(19) United States
(12) Patent Application Publication
(10) Pub. No.: US 2008/0230352 A1
(43) Pub. Date: Sep. 25, 2008

(54) Conveyer apparatus

(76) Inventor: Yasunari Hirata, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 11/725,492

(22) Filed: Mar. 20, 2007

(51) Int. Cl. B65G 45/22

(52) U.S. Cl. 198/495

(57) ABSTRACT

A conveyer apparatus according to the present invention includes a case that defines a pair of right and left gap portions each of which has a predetermined width and extends in a conveying direction of a conveyance object, a conveyer that is arranged near or in a region adjacent to each of the pair of right and left gap portions and supported by the case to support and convey the conveyance object, a driving mechanism that is arranged in an internal space of the case to drive each conveyer, and sucking means for sucking air in the internal space. According to this configuration, when the sucking means sucks air in the internal space in the case, an air current flowing into the internal space from the outside through each gap portion is produced, and an abrasion powder or dust generated near, e.g., each conveyer arranged near under each gap portion flows with this air current to be sucked, thus avoiding scattering toward the outside.

### BACKGROUND OF THE INVENTION

1. Field of the Invention

The present invention relates to a conveyer apparatus that conveys a workpiece, e.g., an electronic component or a mechanical component, and more particularly to a conveyer apparatus suitable for supporting and conveying an electronic component concerning a semiconductor, e.g., a dedicated container (FOUP) that accommodates, e.g., a semiconductor substrate directly or on a pallet in a clean environment, e.g., a semiconductor manufacturing line.

2. Description of the Related Art

In a conventional semiconductor manufacturing line, when conveying a semiconductor substrate (a wafer) to each processing step (a processing device), a technique of accommodating the plurality of substrates in a dedicated container (FOUP) and conveying this container by using a conveyer apparatus is known. This container is hermetically sealed to maintain the inside thereof in a clean environment. On the other hand, since the environment where the container is conveyed is present in the semiconductor manufacturing line, the conveyer apparatus must also cope with achieving cleanness.

As such a conventional conveyer apparatus applied to the semiconductor manufacturing line, there is known a conveyer apparatus including a pair of right and left conveying frames formed of a driving frame and a supporting frame, a coupling member that couples the pair of right and left conveying frames with each other, a plurality of wheels arranged in the driving frame, endless belts that drive the plurality of wheels to interlock with each other; a driving mechanism formed of, e.g., a motor that drives the endless belts to rotate, a housing provided to the conveying frames to surround the driving mechanism with upper parts of the wheels being exposed, and others (see, e.g., PCT Japanese National Publication No. 2003-524544).

However, in this conveyer apparatus, since the pair of right and left conveying frames are independently formed, and then coupled with each other through the coupling member. Therefore, the number of components is large, highly accurate assembling is required in order to assure parallelism of the right and left conveying frames. Further, a reduction in parallelism or levelness in a lateral direction with time must be adjusted, thus leading to an increase in const. Furthermore, although the driving mechanism is surrounded by the housing, an abrasion powder or dust produced from, e.g., a slide part scatters from the housing to the outside, and hence an environment of the semiconductor manufacturing line may be possibly contaminated. Moreover, on a supporting frame side that is not surrounded by the housing, an abrasion power and others produced by sliding may likewise directly scatter to contaminate the environment of the semiconductor manufacturing line.

Thus, even if sucking means for actively sucking an abrasion powder, dust, and others is provided to this apparatus to prevent such an abrasion powder from scattering, the sucking means must be provided for each of the right and left conveying frames since these frames are independent from each other, resulting in an increase in cost.

Additionally, as another conventional conveyer apparatus, there is known one including a pair of right and left conveying frames, a coupling member that couples the pair of right and left conveying frames with each other, a plurality of rollers that are rotatably supported by the pair of right and left conveying frames at both ends and arranged in a conveying direction, a driving shaft arranged in one conveying frame to exert a driving force on one end side of each of the plurality of rollers, a driving mechanism formed of, e.g., a drive transmission belt, an hermetically closed case provided on one conveying frame side to accommodate the driving mechanism therein, a duct through which dust produced in the hermetically closed case is discharged, exhausting means formed of, e.g., a duct, a collection filter or a fan, and others (see, e.g., Japanese Unexamined Patent Publication No. 11-171336).

However, in this conveyer apparatus, the plurality of rollers are arranged in a completely exposed state, a bearing provided in the other conveying frame that supports the other end of each of the plurality of rollers is also exposed. An abrasion powder or dust produced in regions of these members may possibly directly scatter to contaminate the environment of the semiconductor manufacturing line.

### SUMMARY OF THE INVENTION

In view of the above-explained problems, it is an object of the present invention to provide a conveyer apparatus that can prevent an abrasion powder or dust produced in a conveying operation from scattering while achieving, e.g., simplification of a structure, aggregation of respective mechanisms, a reduction in size of the entire apparatus, a reduction in cost, or an improvement in productivity, that readily assure parallelism and levelness of a pair of right and left conveying frames that define a case, and that is easily assembled, and suitable for use in a clean environment, e.g., a semiconductor manufacturing line in particular.

To achieve this object, a conveyer apparatus according to the present invention includes a case that defines a pair of right and left gap portions each of which has a predetermined width and extends in a conveying direction of a conveyance object; a conveyer that is arranged near or in a region adjacent to each of the pair of right and left gap portions and supported by the case to support and convey the conveyance object; a driving mechanism arranged in an internal space of the case to drive each conveyer; and sucking means for sucking air in the internal space.

According to this configuration, when the driving mechanism drives each conveyer, the conveyance object supported by each conveyer is conveyed in a predetermined conveying direction defined by the case. Here, each gap portion is formed with a predetermined width (i.e., a width that is as narrow as possible to provide air sealing). When the sucking means sucks air in an internal space in the case, an air current that flows into the internal space from the outside through the gap portions is generated. Therefore, an abrasion powder or dust produced near each conveyer (or a slide region of, e.g., the driving mechanism) flows with this air current to be sucked by the sucking means, thereby being prevented from scattering to the outside. As a result, even if this conveyer apparatus is used in a clean environment, a required degree of cleanness can be maintained without contaminating this environment.

In the above-explained configuration, it is possible to adopt a configuration where the conveyer is arranged near under each of the pair of right and left gap portions in the internal space of the case, and the conveyance object is a pallet that has leg portions that are inserted into the internal space through the pair of right and left gap portions and supported on the conveyers, and a supporting portion that is supported by the leg portions and positioned above and outside the case to support a workpiece.

According to this configuration, the pallet having the workpiece supported on the supporting portion is conveyed while its leg portions are stably supported by the right and left conveyers placed (in the internal space) near under each gap portion through the pair of right and left gap portions. As a result, smooth and stable conveyance is performed. An abrasion powder or dust produced around the conveyer moves with a downward air current that flows into the internal space from the outside through gap portions, and sucked by the sucking means, thereby being prevented from scattering to the outside.

In the above-explained configuration, it is possible to adopt a configuration where the leg portions of the pallet are formed to be inserted into and removed from the pair of right and left gap portions without restraint.

According to this configuration, since the leg portions of the pallet can be inserted and removed through the gap portions, attachment and detachment of the pallet with respect to this conveyer apparatus (the conveyers) can be facilitated.

In the above-explained configuration, it is possible to adopt a configuration where the case includes a lower case that has a pair of right and left conveying frames extending in the conveying direction and a planar frame that couples lower parts of the pair of conveying frames with each other and an upper cover that faces the planar frame from above to define the internal space in a closed manner and faces the pair of conveying frames from the inside in a lateral direction to define the pair of right and left gap portions.

According to this configuration, since the pair of right and left conveying frames of the lower case and the upper cover define the pair of right and left gap portions and the internal space, appropriately adjusting gap distances between (right and left edge portions of) the upper cover and the pair of right and left conveying frames can readily define the gap portions each having a predetermined width.

In the above-explained configuration, it is possible to adopt a configuration where the pair of right and left conveying frames and the planar frame are integrally molded.

According to this configuration, since the pair of right and left conveying frames and the planar frame are integrally molded, an assembling operation is no longer necessary. Further, integral molding accurately assures parallelism and levelness of the right and left frames, which eliminates an operation of adjusting parallelism and levelness, thus reducing a manufacturing cost and a management cost.

In the above-explained configuration, it is possible to adopt a configuration where the upper cover is formed to be detachable with respect to the lower case.

According to this configuration, when periodically performing maintenance, removing the upper cover enables an inspecting operation or a cleaning operation to be easily performed.

In the above-explained configuration, it is possible to adopt a configuration where the conveyer is an endless belt that is stretched in the conveying direction (a front-and-back direction) and arranged in the internal space, and an upper belt placed on an upper side of the endless belt is arranged to face each of the gap portions from below.

According to this configuration, each entire endless belt is accommodated in the internal space defined by the lower case and the upper cover, and the conveyance object is conveyed in the front-and-back direction in a state where it is supported by the upper belt through the upper gap portion. Therefore, this configuration is suitable for conveying a workpiece (e.g., an electronic component or a container accommodating an electronic component) via, e.g., a pallet having leg portions inserted into the gap portions in a non-contact manner. Further, since the conveyers (the endless belts) and the driving mechanism are all accommodated in the internal space, a produced abrasion powder or dust can be further reliably prevented from scattering to the outside.

In the above-explained configuration, it is possible to adopt a configuration where the conveyer is a roller chain having a plurality of rollers that is stretched in the conveying direction (the front-and-back direction) and arranged in the internal space, and an upper chain placed on an upper side of the roller chain is arranged to face each of the gap portions from below.

According to this configuration, the entire roller chain is accommodated in the internal space defined by the lower case and the upper cover, and a conveyance object is conveyed in the front-and-back direction in a state where it is supported by (the plurality of rollers of) the upper chain through the upper gap portion.

Therefore, this configuration is suitable for conveying a workpiece (e.g., an electronic component or a container accommodating an electronic component) via, e.g., a pallet having leg portions inserted into the gap portions in a non-contact manner. Furthermore, since the conveyers (the roller chains) and the driving mechanism are all accommodated in the internal space, a produced abrasion powder or dust can be further reliably prevented from scattering to the outside.

Moreover, since each conveyer is the rolling roller chain, generation of, e.g., an abrasion powder can be suppressed as compared with an example where each conveyer slides, thereby effectively avoiding generation of, e.g., dust in cooperation with a sucking action that occurs in the gap portions.

Additionally, when a double-speed chain is used as the roller chain, since a conveyance object is conveyed at a speed obtained by adding a speed for conveying the chain by the driving mechanism to a rotating speed of the roller, thus enabling conveyance at a higher speed while maintaining a required degree of cleanness.

In the above-explained configuration, it is possible to adopt a configuration where the conveyer is an endless belt stretched in the conveying direction (the front-and-back direction), and an upper belt placed on an upper side of the endless belt is arranged near each of the gap portions.

According to this configuration, the upper belt of the endless belt is arranged near each gap portion in an exposed state, the lower belt is accommodated in the internal space defined by the lower case and the upper cover, and a conveyance object is conveyed in the front-and-back direction in a state where it is supported by the exposed upper belt. Therefore, as compared with an example where the upper belt is accommodated inside and a workpiece is conveyed via, e.g., a pallet, a conveyance height can be reduced by an amount corresponding to exposing amount of the upper belt that supports a workpiece, thereby reducing a size of the apparatus. Furthermore, since the endless belt (the upper belt) is arranged near each gap portion, an abrasion powder or dust produced near the upper belt moves with an air current generated in each gap portion and flows into the internal space, thus suppressing or avoiding scattering of the abrasion powder or dust.

In the above-explained configuration, it is possible to adopt a configuration where the conveyer is a plurality of rollers arranged in a region of each of the gap portions in a non-contact manner, and upper parts of the plurality of rollers protrude from each of the gap portions to support the conveyance object.

According to this configuration, since the plurality of rollers are arranged without being in contact with region of each gap portion in such a manner that upper parts thereof protrude toward the outside, a conveyance object is conveyed in the front-and-back direction in a state where it is supported by the exposed upper parts of the rollers, and an air current flowing inwards is generated in a gap between the rollers and the case defining each gap portion. Therefore, as compared with an example where the rollers are completely accommodated and a workpiece is conveyed via, e.g., a pallet, a conveyance height can be reduced by an amount corresponding to an exposing amount of the upper parts of the rollers that support the workpiece, thus reducing a size of the apparatus. The air current flowing inward around the rollers can reliably prevent an abrasion powder or dust generated in the internal space from scattering to the outside.

In the above-explained configuration, it is possible to adopt a configuration where the sucking means includes a plurality of suction openings provided on a lower side at a substantially central position of the case in a lateral direction to be aligned in the conveying direction (the front-and-back direction), and a suction path communicating with the plurality of suction openings.

According to this configuration, when sucking air in the internal space defined by the case, since the suction openings are provided on the lower side of the case and the suction path communicates with the suction openings, an air current flowing downward from each gap portion can be actively generated.

In the above-explained configuration, it is possible to adopt a structure where the sucking means includes a plurality of suction openings provided at a substantially central position of the lower case in a lateral direction to be aligned in the conveying direction (the front-and-back direction), and a suction path communicating with the plurality of suction openings.

According to this configuration, when sucking air in the internal space defined by the lower case and the upper cover, since the suction openings are provided in the lower case and the suction path communicates with the suction openings, an air current that is downwardly sucked can be generated even if the upper cover is removed. As a result, when the upper cover is removed to perform maintenance, activating the sucking means can avoid scattering of an abrasion powder or dust. Moreover, since the plurality of suction openings are arranged at a substantially central part of the lower case, a region where stagnation occurs can be prevented from being generated, and suction can be efficiently carried out in every corner as a whole. Additionally, providing a single suction device, e.g., a fan that generates a sucking force can suffice, resulting in simplification of the sucking means and a reduction in cost.

In the above-explained configuration, it is possible to adopt a structure where a guide portion that engages with a part of the conveyance object and guides the conveyance object in the conveying direction (the front-and-back direction) is provided to the case.

According to this configuration, when supporting and conveying a conveyance object in a state where each conveyer (e.g., the upper belt of the endless belt or the upper parts of the rollers) is exposed, guiding a part of the conveyance object (e.g., a guided portion formed to downwardly protrude from the pallet) by using a guide portion of the case enables reliably conveying the conveyance object in the front-and-back direction without displacement in a lateral direction.

As explained above, according to the conveyer apparatus of the present invention, an abrasion powder or dust produced in a conveying operation can be prevented from scattering while achieving simplification of the structure, aggregation of the respective mechanisms, a reduction in size of the entire apparatus, a reduction in cost, an improvement in productivity, and others. Further, parallelism and levelness of the pair of right and left conveying frames that define the case can be easily assured, thus facilitating assembling.

### BRIEF DESCRIPTION OF THE DRAWINGS

FIG. 1 is a front view showing an embodiment of a conveyer apparatus according to the present invention;

FIG. 2 is a plan view of the conveyer apparatus shown in FIG. 1;

FIG. 3 is a partial cross-sectional view of the conveyer apparatus depicted in FIG. 1 in a conveying direction;

FIG. 4 is a cross-sectional view of the conveyer apparatus shown in FIG. 1 in a direction perpendicular to the conveying direction;

FIG. 5 is an exploded cross-sectional view showing a frame structure of the conveyer apparatus shown in FIG. 1 in an exploded manner;

FIG. 6 is a cross-sectional view of the conveyer apparatus in the direction perpendicular to the conveying direction showing a modification of a pallet as a conveyance object;

FIG. 7 is a partial cross-sectional view in the conveying direction showing another embodiment of the conveyer apparatus according to the present invention;

FIG. 8 is a cross-sectional view of the conveyer apparatus shown in FIG. 7 in a direction perpendicular to a conveying direction;

FIG. 9 is a plan view showing still another embodiment of the conveyer apparatus according to the present invention;

FIG. 10 is a cross-sectional view of the conveyer apparatus shown in FIG. 9 in a direction perpendicular to a conveying direction;

FIG. 11 is a cross-sectional view showing a modification of the conveyer apparatus shown in FIGS. 9 and 10;

FIG. 12 is a plan view showing yet another embodiment of the conveyer apparatus according to the present invention;

FIG. 13 is a cross-sectional view of the conveyer apparatus shown in FIG. 12 in a direction perpendicular to a conveying direction; and

FIG. 14 is a cross-sectional view showing a modification of the conveyer apparatus shown in FIGS. 12 and 13.

### DETAILED DESCRIPTION OF THE PREFERRED EMBODIMENTS

Best embodiments of the present invention will now be explained hereinafter with reference to the accompanying drawings.

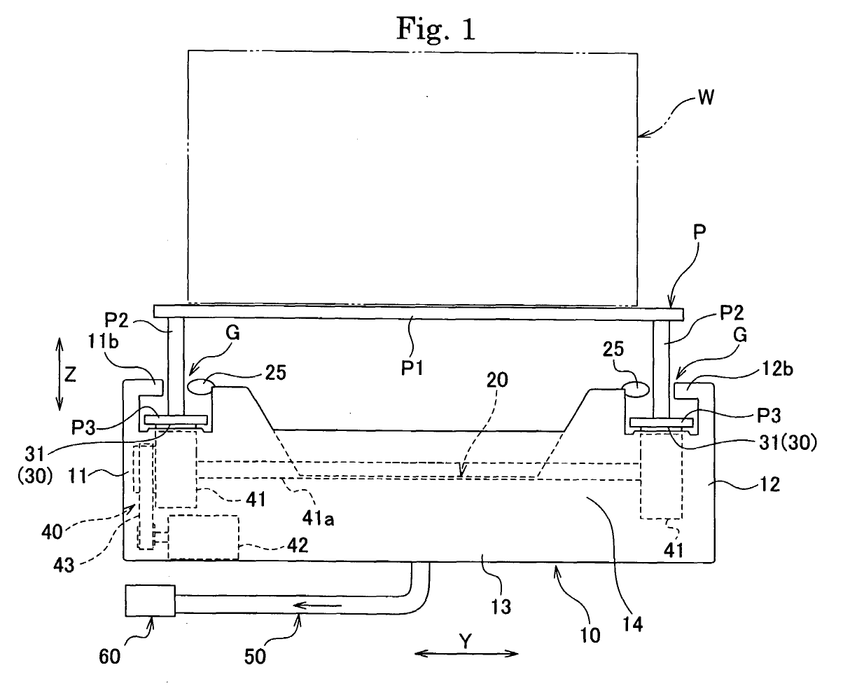

As shown in FIGS. 1 to 5, this conveyer apparatus includes a lower case 10 forming a part of a case, an upper cover 20 that is coupled with the lower case 10 and forms a part of the case, each endless belt 30 as a conveyer that is accommodated in an internal space S defined by the lower case 10 and the upper cover 20, a driving mechanism 40 that drives each endless belt 30, an exhaust duct 50 and a suction device 60 as sucking means connected with the lower case 10 to suck air in the internal space S, and others.

It is to be noted that this conveyer apparatus is configured to convey a workpiece W, e.g., a container (FOUP) accommodating a semiconductor substrate and a pallet P supporting the workpiece W as the conveyance object. Here, as shown in FIGS. 1 to 3, the pallet P includes a planar supporting portion P1 that supports the workpiece W, leg portions P2 downwardly extending from both right and left ends of the supporting portion P1, tabular base portions P3 that are coupled with lower ends of the leg portions P2 and supported by the endless belts 30, and others. The base portion P3 may be integrally formed as a part of the leg portion P2.

The lower case 10 includes a pair of right and left conveying frames 11 and 12 extending in a front-and-back direction X, a planar frame 13 that couples lower sides of the pair of conveying frames 11 and 12 with each other, and others. The pair of conveying frames 11 and 12 and the planar frame 13 are integrally formed by pultrusion (drawing) molding using an aluminum material.

Further, as shown in FIG. 1, a partition wall 14 is disposed at an end of the lower case 10 in a conveying direction (the front-and-back direction) X as required. When this conveyer apparatus is used in a linear arrangement, the partition wall 14 closes an end thereof. The partition wall 14 is not required when this conveyer apparatus is used in an annular arrangement forming a closed loop.

That is, since the lower case 10 is integrally molded, an assembling operation is not necessary as compared with an example where the conveying frame 11, the conveying frame 12, and the planar frame 13 are individually molded and then assembled. Furthermore, since a forming die has a high accuracy, mutual parallelism and levelness of the conveying frames 11 and 12 can be accurately assured. As a result, the number of components can be reduced, and an adjustment operation required to provide parallelism and levelness is no longer necessary, thereby reducing a cost.

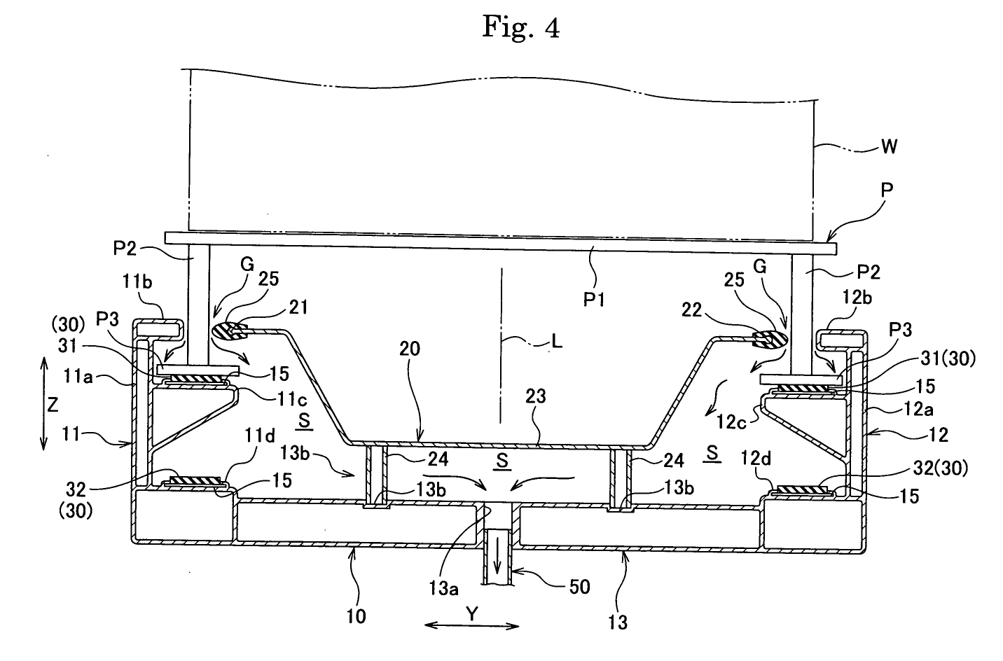

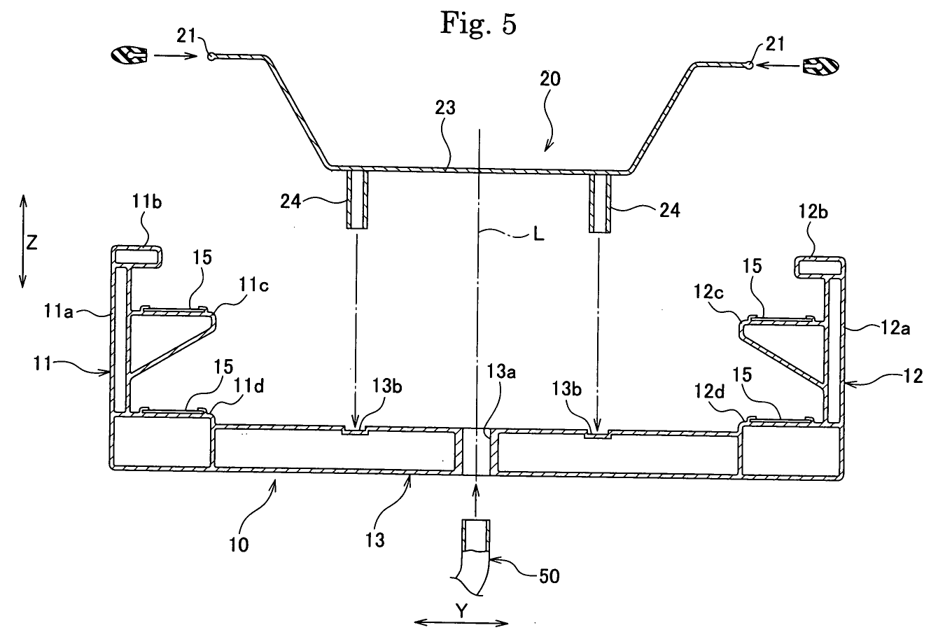

As shown in FIGS. 4 and 5, the pair of right and left conveying frames 11 and 12 have a symmetrical shape with respect to a central line L, and include vertical wall portions 11a and 12a, upper end flange portions 11b and 12b, upper supporting portions 11c and 12c formed to protrude from inner middle parts of the vertical wall portions 11a and 12a, lower supporting portions 11d and 12d formed to extend inwards from lower ends of the vertical wall portions 11a and 12a, and others.

The vertical wall portions 11a and 12a, the upper end flange portions 11b and 12b, the upper supporting portions 11c and 12c, and the lower supporting portions 11d and 12d are respectively formed to have cavities therein, thereby enhancing flexural rigidity, i.e., mechanical strength. It is to be noted that such a cavity has a rectangular or triangular cross section and is formed to extend in a pultruding direction (the front-and-back direction X).

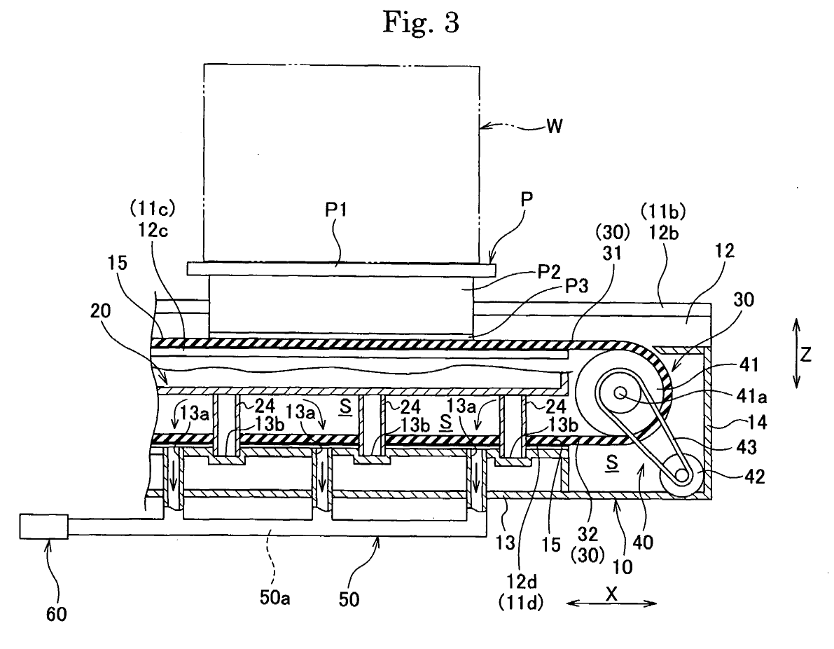

As shown in FIGS. 3 and 5, a plurality of suction openings 13a arranged in the front-and-back direction X are formed at the center of the planar frame 13 in a lateral direction Y to pierce in a vertical direction Z by post-processing. Moreover, a plurality of fitting holes 13b in which column supports 24 of the later-explained upper cover 20 are fitted are formed in an upper surface of the planar frame 13 defining the internal space S.

Here, as shown in FIGS. 3 and 4, pads 15 that have a small slide resistance and are superior in abrasion resistance are provided on upper surfaces of the upper supporting portions 11c and 12c and the lower supporting portions 11d and 12d to slidably support the endless belts 30.

As shown in FIGS. 4 and 5, the upper cover 20 includes edge portions 21 and 22 that face the upper end flange portions 11b and 12b of the pair of right and left conveying frames 11 and 12 from the inner side in the lateral direction Y, a concave portion 23 that faces the planar frame 13 of the lower case 10 in the vertical direction Z, a plurality of hollow column supports 24 coupled with a lower surface of the concave portion 23, and others. The both edge portions 21 and 22 and the concave portion 23 are integrally formed by pultrusion (drawing) molding using an aluminum material, and formed to extend in the conveying direction (the front-and-back direction) X in a planar manner and form a concave surface that a cross section in the lateral direction Y is downwardly depressed. Additionally, the column supports 24 are coupled with the lower surface of this concave portion 23, and guide members 25 extending in the front-and-back direction X are detachably disposed to the both edge portions 21 and 22.

Here, since the upper cover 20 is formed into a concave shape, the internal space S defined by the upper cover 20 together with the lower case 10 can be formed into a required minimum size, and a wasteful space can be eliminated to intensify a flow of an air current, thereby increasing a sucking (exhausting) efficiency for an abrasion powder or dust.

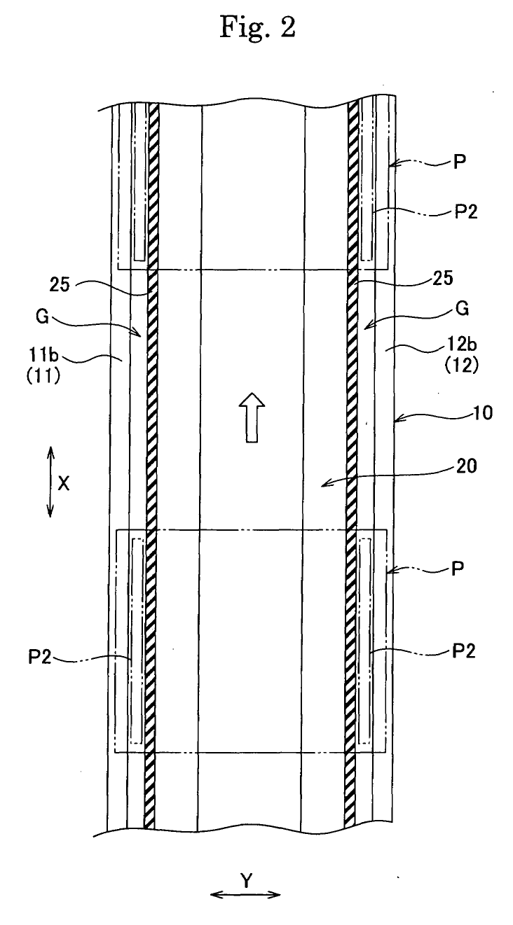

As shown in FIGS. 2 and 4, the guide members 25 are formed of, e.g., a resin material, and the guide members 25 together with the upper flange portions 11b and 12b of the pair of right and left conveying frames 11 and 12 (i.e., the case) define a pair of right and left gap portions G that extend in the conveying direction (the front-and-back direction) X and have a predetermined width in the lateral direction Y.

That is, in a state where the upper cover 20 is assembled to the lower case 10, when an attachment position (i.e., a fitting depth) of each guide member 25 is allowed to be adjusted, a width dimension of each gap portion G can be appropriately adjusted. Further, the guide members 25 assuredly guide the leg portions P2 of the pallet P as a part of a conveyance object that is supported and conveyed by each endless belt 30 (a later-explained upper belt 31) in the front-and-back direction (the conveying direction) X while restricting meandering due to a displacement in the lateral direction.

Furthermore, as shown in FIG. 5, when the column supports 24 are fitted in the fitting holes 13b, the upper cover 20 is detachably coupled with the lower case 10. Since the upper cover 20 is formed to be detachable with respect to the lower case 10 in this manner, removing the upper cover 20 when performing periodic maintenance readily enables an inspecting operation or a cleaning operation.

As shown in FIGS. 3 and 4, the endless belt 30 as the conveyer is arranged to be completely accommodated in the internal space S and placed near under each gap portion G, and stretched in the conveying direction (the front-and-back direction) X by a driving pulley 41 and a driven pulley (not shown) that will be explained later. Further, the upper belt 31 is slidably supported on the upper supporting portion 11c or 12c (the pad 15) of the conveying frame 11 or 12 and arranged to face the gap portion G from the lower side. As a result, the belt travels forward while supporting each leg portion P2 (and the base portion P3) of the pallet P that has entered through the gap portion G. Furthermore, the lower belt 32 is slidably supported on the lower supporting portion 11d or 12d (the pad 15) of the conveying frame 11 or 12, thereby traveling backward.

As shown in FIGS. 1 and 3, the driving mechanism 40 is arranged in the internal space S defined by the lower case 10 and the upper cover 20 and held in the lower case 10. The driving mechanism 40 includes a pair of right and left driving pulleys 41 integrally coupled with each other via a shaft 41a to exert a driving force to the right and left endless belts 30, a motor 42, a transmission belt 43 interposed between the motor 42 and the driving pulley 41, and others.

That is, when the motor 42 rotates, the driving pulleys 41 rotate via the transmission belt 43, and the endless belts 30 further rotate, thereby conveying the pallet P supporting the workpiece W in the front-and-back direction X.

It is to be noted that the right and left driving pulleys 41 may be driven by the respective motors 42 without using the shaft 41a.

As shown in FIGS. 1 and 3 to 5, the exhaust duct 50 communicates with each of the plurality of suction openings 13a provided in the lower case 10, and a downstream side of the exhaust duct 50 defines one suction path 50a to be connected with the suction device 60.

As the suction device 60, it is possible to adopt a fan, a pump, or any other mechanism as long as it sucks air in the internal space S and generates an air current flowing toward the inside from the outside at the gap portion G.

Explaining an operation of this conveyer apparatus, when the motor 42 rotates and the endless belts 30 travel via the transmission belt 43 and the driving pulleys 41, the conveyance object (the pallet P and the workpiece W) supported on the upper belts 31 is conveyed in the front-and-back direction X along the pair of right and left conveying frames 11 and 12.

Here, in this conveying operation, when the suction device 60 operates to suck air in the internal space S defined by the lower case 10 and the upper cover 20, a downward air current that flows into the internal space from the outside via each gap portion G is generated as indicated by each arrow in FIG. 4, thereby forming air sealing. Therefore, an abrasion powder or dust produced in a contact region with respect to each endless belt 3 supporting the pallet P or a slide region of, e.g., the driving mechanism 40 flows with this downward air current to be discharged from the suction openings 13a to a predetermined discharge opening provided outside the semiconductor manufacturing line through the suction path 50a, thereby avoiding scattering to the outside from the conveyer apparatus. As a result, even if this conveyer apparatus is used in a clean environment, a required degree of cleanness can be maintained without contaminating this environment.

Here, in particular, the endless belts 30 and the driving mechanism 40 are all accommodated in the internal space S, and each endless belt 30 is arranged near under each gap portion G. Therefore, the downward air current flowing through each gap portion G actively flows through the region of each endless belt 30, and a produced abrasion powder or dust can be assuredly prevented from scattering to the outside.

Moreover, since the plurality of suction openings 13a are arranged at the substantially central part of the lower case 10, a region where stagnation occurs can be prevented from being generated in the internal space S. As a result, efficient suction can be effected in every corner as a whole, and providing just one suction device 60, e.g., a fan that produces a suction force can suffice, thus simplifying the apparatus and reducing a cost.

Additionally, since the suction openings 13a are provided in the lower case 10 and the suction path 50a communicates with the suction openings 13a, an air current that is downwardly sucked can be produced even if the upper cover 20 is removed.

Therefore, when the conveying operation is stopped and the upper cover 20 is removed to perform maintenance, activating the suction device 60 can prevent an abrasion powder or dust from scattering. Further, in maintenance, since the lower case 10 is integrally molded, parallelism and levelness of the right and left conveying frames 11 and 12 do not have to be adjusted, thus simplifying the maintenance operation.

As a result, even if this conveyer apparatus is used in a clean environment, a required degree of cleanness can be maintained without contaminating this environment.

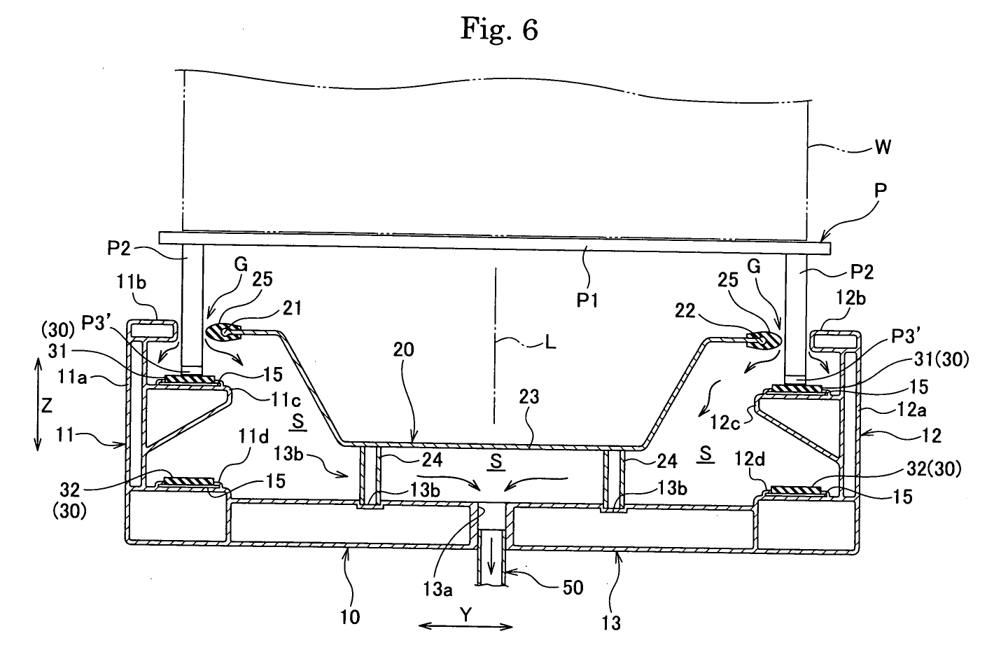

FIG. 6 shows an embodiment where the pallet P as a conveyance object applied to the conveyer apparatus is partially modified.

In this embodiment, as shown in FIG. 6, a pallet P includes a planar supporting portion P1 that supports a workpiece W, leg portions P2 that downwardly extend from both right and left ends of the supporting portion P1 to enter an internal space S through respective gap portions G, base portions P3′ that are coupled with the leg portions P2, supported by endless belts 30, and have substantially the same widths as the leg portions P2, and others.

In this example, the base portion P3′ is formed to have a width narrower than the gap portion G, and the leg portion P2 (and the base portion P3′) is formed to be inserted into or removed from each gap portion G without restraint. Therefore, since each leg portion P2 of the pallet P can be inserted or removed through each gap portion G, the pallet P can be readily attached/detached with respect to this conveyer apparatus (a conveyer).

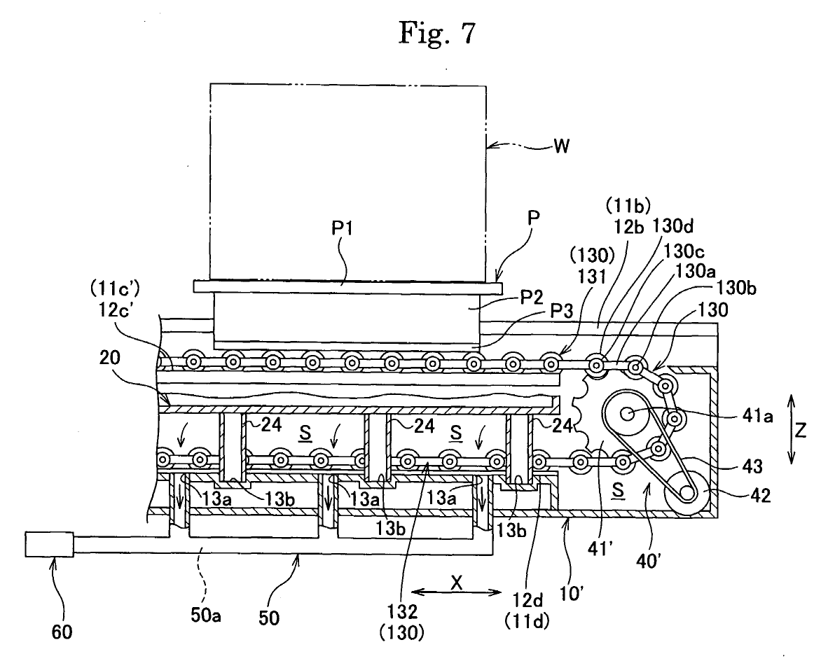

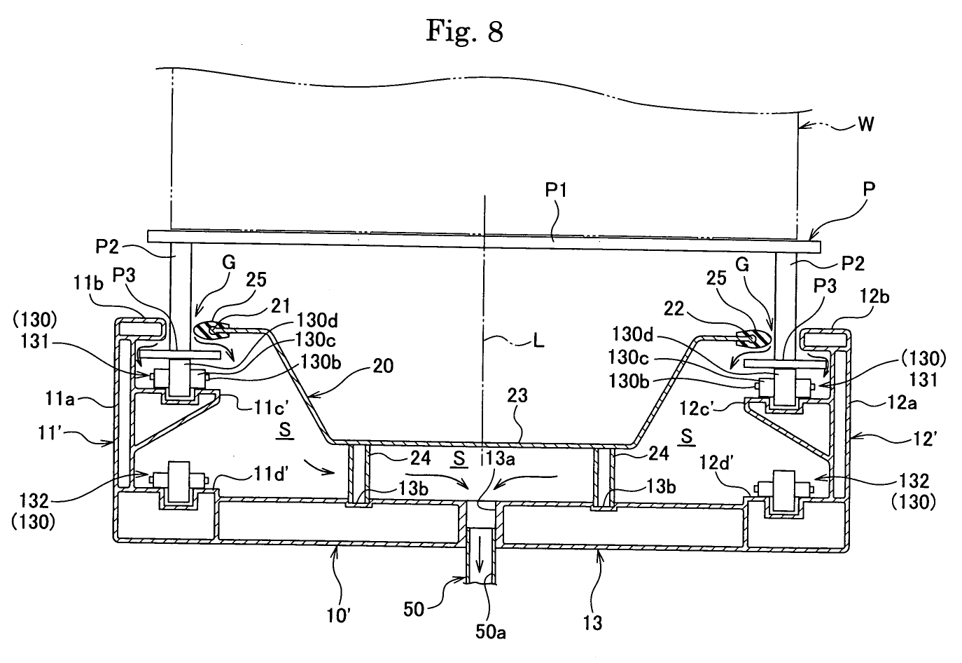

FIGS. 7 and 8 show another embodiment of the conveyer apparatus according to the present invention. This embodiment has the same structure as that of the foregoing embodiment except that roller chains, e.g., double-speed chains 130 are adopted as conveyers and the conveying frames are partially changed. Therefore, like reference numerals denote the same structures, thereby omitting an explanation thereof.

That is, in this conveyer apparatus, as shown in FIGS. 7 and 8, double-speed chains 130 and a driving mechanism 40′ thereof are arranged in an internal space S defined by a lower case 10′ and an upper cover 20.

The double-speed chain 130 is formed of a plurality of plates 130a coupled with each other, a plurality of pins 130b coupling the plates 130a with each other, a plurality of small-diameter rollers 130c rotatably supported by the pins 130b, and a plurality of large-diameter rollers 130d arranged coaxially with the rollers 130c. In this example, the large-diameter roller 130d is formed to integrally rotate with the small-diameter roller 130c based on a frictional force. When a load exceeding a predetermined level is applied to the roller 130d, the roller 130c alone rotates while the roller 13d stops.

As shown in FIGS. 7 and 8, each double-speed chain 130 is completely accommodated in the internal space S, arranged near under each gap portion G, and stretched in a conveying direction (a front-and-back direction) X by a driving sprocket 41′ and a driven sprocket (not shown) that will be explained later.

Further, the rollers 130c of an upper chain 131 are rotatably supported on upper supporting portions 11c′ and 12c′ of conveying frames 11′ and 12′, and the rollers 130d are arranged to face the gap portions G from the lower side. As a result, the rollers 130d travel forward while supporting the leg portions P2 (and the base portions P3) of the pallet P entering through the gap portions G. Furthermore, the rollers 130c of a lower chain 132 are rotatably supported on lower supporting portions 11d′ and 12d′ of the conveying frames 11′ and 12′, and the rollers 130d integrally travel backward.

As shown in FIGS. 7 and 8, the driving mechanism 40′ is arranged in the internal space S and held in the lower case 10. The driving mechanism 40′ includes a pair of right and left driving sprockets 41′ integrally coupled with each other via a shaft 41a to exert a driving force to the right and left double-speed chains 130, a motor 42, a transmission belt 43, and others.

Therefore, when the motor 42 rotates, the driving sprockets 41′ rotate via the transmission belt 43, and the double chains 130 rotate and travel. As a result, a supported conveyance object (the pallet P supporting the workpiece W) is conveyed in the front-and-back direction X while the rollers 130d of the upper chain 131 roll. Here, the conveyance object (the pallet P supporting the workpiece W) is conveyed at a speed obtained by adding a speed at which the double-speed chains 130 are conveyed by the driving mechanism 40′ to a rotating speed of the rollers 130d, thereby enabling conveyance at a higher speed.

In this embodiment, likewise, the double-speed chains 130 and the driving mechanism 40′ are all accommodated in the internal space S, and each double-speed chain 130 is arranged near under each gap portion G. Therefore, a downward air current flowing through each gap portion G actively flows through a region of each double-speed chain 130, thereby assuredly preventing a generated abrasion powder or dust from scattering to the outside.

It is to be noted that such a pallet P having each base portion P3′ with a narrow width as shown in FIG. 6 may be likewise applied in the embodiment shown in FIGS. 7 and 8.

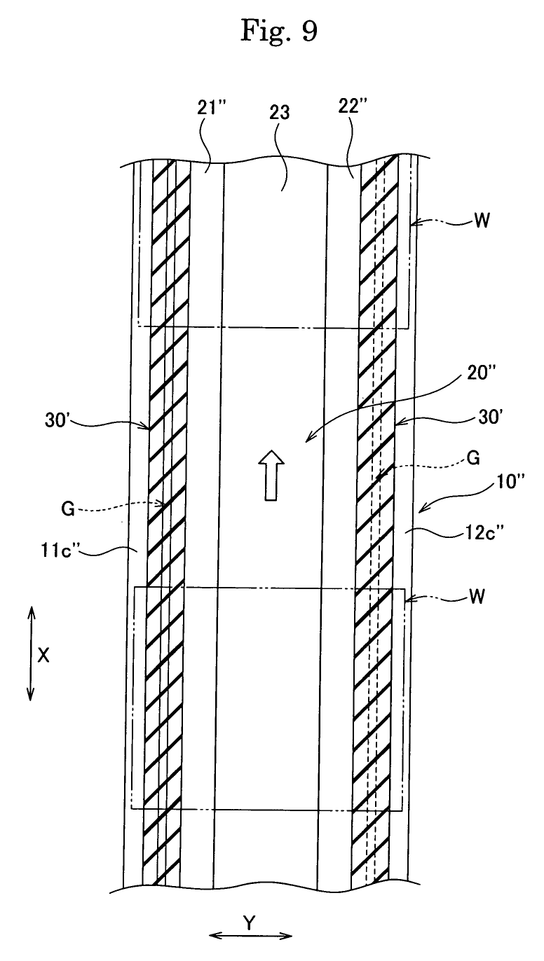

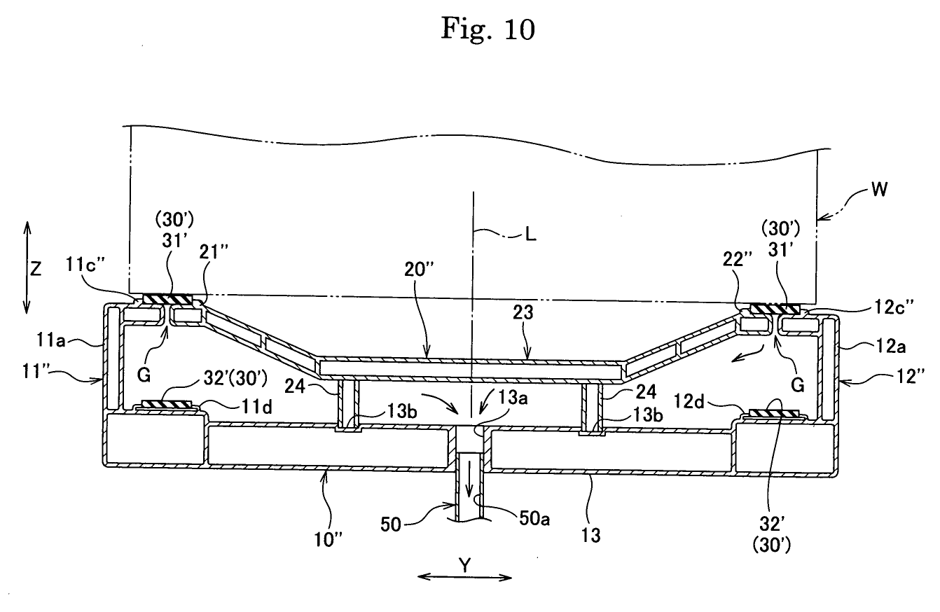

FIGS. 9 and 10 show still another embodiment of the conveyer apparatus according to the present invention, and this embodiment is the same as the embodiment shown in FIGS. 1 to 5 except that arrangements and others of the lower case 10″, the upper cover 20″, and the endless belt 30′ are changed. Therefore, like reference numerals denote the same structures, thereby omitting an explanation thereof.

In this conveyer apparatus, as shown in FIGS. 9 and 10, a lower case 10″ includes a pair of right and left conveying frames 11″ and 12″ extending in a conveying direction (a front-and-back direction) X, a planar frame 13 that couples lower parts of the pair of conveying frames 11″ and 12″ with each other, and others. As shown in FIGS. 9 and 10, the pair of right and left conveying frames 11″ and 12″ have a symmetrical shape with respect to a central line L, and respectively include vertical wall portions 11a and 12a, upper supporting portions 11c″ and 12c″, lower supporting portions 11d and 12d, and others.

As shown in FIGS. 9 and 10, the upper cover 20″ is formed to have a cavity inside, thereby enhancing flexural rigidity, i.e., mechanical strength. It is to be noted that this cavity is formed to have a rectangular or triangular cross section and extend in a pultruding direction of a pultrusion (drawing) molding (the front-and-back direction X).

This upper cover 20″ includes supporting portions 21″ and 22″ that face the upper supporting portions 11c″ and 12c″ of the pair of right and left conveying frames 11″ and 12″ from the inner side in a lateral direction Y, a concave portion 23, column supports 24, and others.

Further, when the upper cover 20″ is coupled with the lower case 10″, as shown in FIG. 9, each gap portion G that extends in the conveying direction X of a conveyance object (a workpiece W) and has a predetermined width is defined between the upper supporting portion 11c″ and the supporting portion 21″ and between the upper supporting portion 12c″ and the supporting portion 22″.

As shown in FIGS. 9 and 10, each endless belt 30′ is slidably supported on the upper supporting portion 11c″ or 12c″ and the supporting portion 21″ or 22″ in a state where an upper belt 31′ traveling forward on an upper side is exposed to the outside, namely, it is arranged to be adjacent to (contact with) each gap portion G from above. A lower belt 32′ that travels backward on a lower side is slidably supported on the lower supporting portion 11d or 12d in the internal space S.

According to this embodiment, the workpiece W as a conveyance object is conveyed in the front-and-back direction X in a state where it is supported by the exposed upper belt 31′. Therefore, when the upper belt 31′ is exposed to directly support the workpiece W, a conveyance height can be reduced by an amount corresponding to a height of each leg portion P2 as compared with an example where each upper belt 31 is accommodated inside to support the workpiece W through each leg portion P2 like the embodiment shown in FIG. 4, thus reducing a size of the apparatus.

Moreover, the endless belt 30′ (the upper belt 31′) is adjacent to the gap portion G so as to close the gap portion G, and hence an abrasion powder or dust can be prevented from scattering toward the outside. On the other hand, in a region where the workpiece W is not supported (a load is not received), a small gap may be produced among the endless belt 30′ and the upper supporting portion 11c″ or 12c″ and the supporting portion 21″ or 22″ defining the gap portion G. However, since a downward air current flowing toward the inner space S is generated by the suction device 60, an abrasion powder or dust produced in the internal space S can be assuredly prevented from scattering toward the outside.

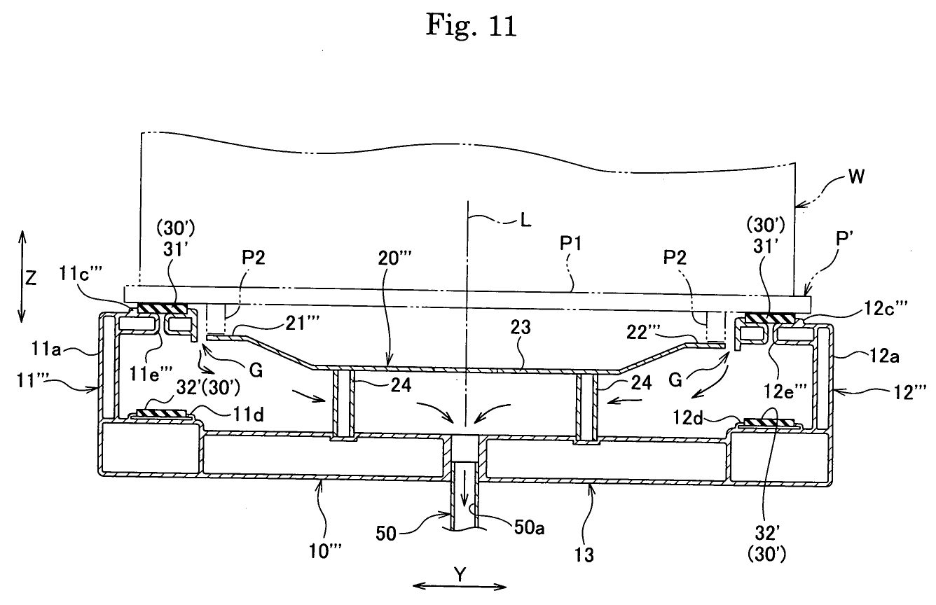

FIG. 11 shows an example obtained by partially changing the lower case and the upper cover of the conveyer apparatus shown in FIGS. 9 and 10. It is to be noted that a workpiece W and a pallet P′ are applied as a conveyance object, and the pallet P′ includes a supporting portion P1 and each leg portion P2 as a guided portion.

That is, in this conveyer apparatus, as shown in FIG. 11, a lower case 10′″ includes a pair of right and left conveying frames 11′″ and 12′″ extending in a conveying direction (a front-and-back direction) X, and a planar frame 13 that couples lower parts of the pair of conveying frames 11′″ and 12′″ with each other.

The pair of right and left conveying frames 11′″ and 12′″ have a symmetrical shape with respect to a central line L, and respectively include vertical wall portions 11a and 12a, upper supporting portions 11c′″ and 12c′″, lower supporting portions 11d and 12d, a plurality of circular holes 11e′″ and 12e′″ arranged at substantially central positions of the upper supporting portions 11c′″ and 12c′″ in the conveying direction (the front-and-back direction) X, and others.

An upper cover 20″ includes edge portions 21′″ and 22′″ that face the upper supporting portions 11c′″ and 12c′″ of the pair of right and left conveying frames 11′″ and 12′″ from the inner side in a lateral direction Y to define respective gap portions G, a concave portion 23, column supports 24, and others.

Additionally, inner surfaces of the upper supporting portions 11c′″ and 12c′″ of the pair of right and left conveying frames 11′″ and 12′″ function as a pair of right and left guide portions that engage with and guide the leg portions P2 of the pallet P′ (a part of the conveyance object) in the conveying direction (the front-and-back direction X).

According to this configuration, when mounting the pallet P′ supporting the workpiece W on the upper belt 31′ of each endless belt 30′ to be conveyed, since the inner surfaces of the right and left upper supporting portions 11c′″ and 12c′″ as the guide portions guide the leg portions P2. Therefore, the conveyance object (the workpiece W and the pallet P′) is assuredly conveyed in the front-and-back direction without displacement in the lateral direction Y, and an air current flowing into the inner space S from each gap portion G is generated, thereby preventing a generated abrasion powder or dust from scattering. Further, an abrasion powder or the like generated by a sliding motion of the upper belt 31′ is sucked into the internal space S through the circular holes 11e′″ or 12′″, thus avoiding scattering toward the outside.

In the embodiment shown in FIGS. 9 to 11, although the endless belts 30′ are directly supported by the conveying frames 11″, 11′″, 12″, and 12′″, but the endless belts 30′ may be supported through pads 15 as explained above.

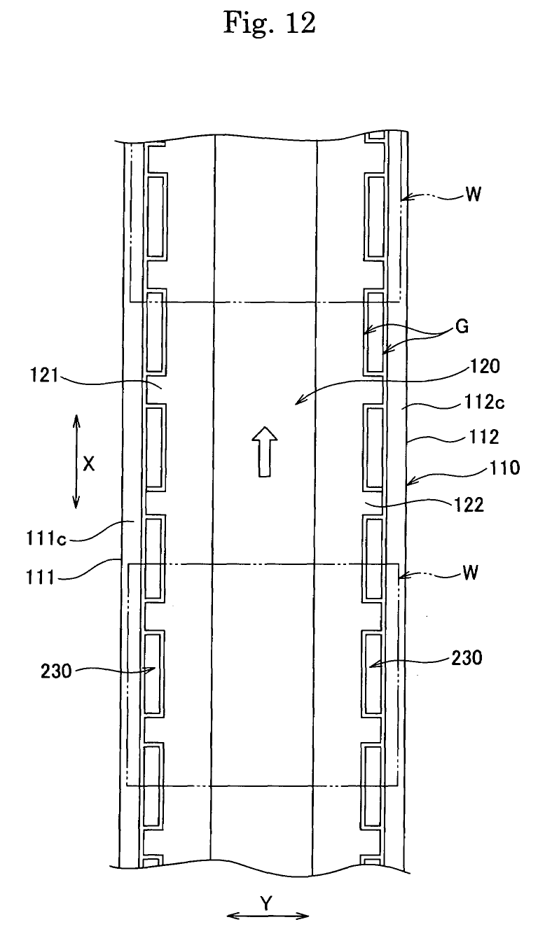

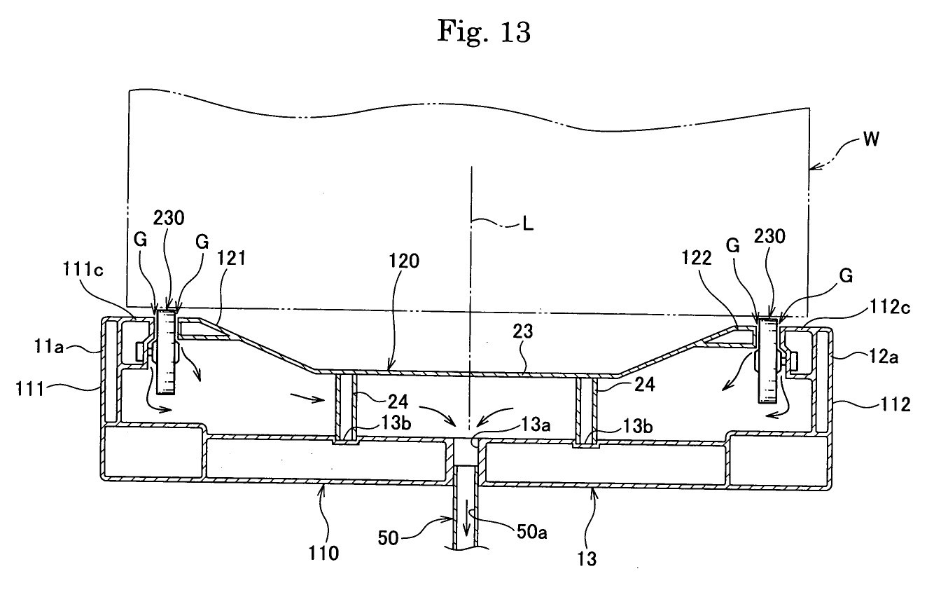

FIGS. 12 and 13 show yet another embodiment of the conveyer apparatus according to the present invention. This embodiment is basically the same as the embodiment shown in FIGS. 9 and 10 except that the lower case 110 and the upper cover 120 are changed and a plurality of interlocking rollers 230 as a conveyer are adopted. Therefore, like reference numerals denote like structures, thereby omitting an explanation thereof.

In this conveyer apparatus, as shown in FIGS. 12 and 13, a lower case 110 includes a pair of right and left conveying frames 111 and 112 extending in a conveying direction (a front-and-back direction) X, a planar frame 13 that couples lower parts of the pair of conveying frames 111 and 112 with each other, and others.

As shown in FIGS. 12 and 13, the pair of right and left conveying frames 111 and 112 have a symmetrical shape with respect to a central line L, and respectively include vertical wall portions 11a and 12a, upper end flange portions 111c and 112c, and others.

As shown in FIGS. 12 and 13, an upper cover 120 includes edge portions 121 and 122 facing the upper end flange portions 111c and 112c of the pair of right and left conveying frames 111 and 112 from the inner side in a lateral direction Y, a concave portion 23, column supports 24, and others.

Further, when the upper cover 120 is coupled with the lower case 110, as shown in FIG. 12, a pair of right and left gap portions G each having a predetermined width are defined between the upper end flange portion 111c and the edge portion 121 and between the upper end flange portion 112 and the edge portion 122.

As shown in FIGS. 12 and 13, a plurality of rollers 230 are rotatably supported by spindles provided on inner walls of the upper end flange portions 111c and 112c of the pair of right and left conveying frames 111 and 112, aligned in the conveying direction (the front-and-back direction) X, and arranged without being in contact with regions of the respective gap portions G. Furthermore, upper parts of the plurality of rollers 230 protrude toward the outside (the upper side) from the gap portions G to support a workpiece W as a conveyance object.

In this example, a chain or a belt (not shown) is would around each pulley or sprocket (not shown) formed with a diameter smaller than that of each roller 230 in such a manner that the plurality of rollers 230 interlock with each other and the pulley or the sprocket coaxially and integrally rotate with each roller 230. When the driving mechanism 40 or 40′ gives a rotation driving force to one roller 230, all the rollers 230 rotate.

According to this embodiment, the plurality of rollers 230 are arranged in such a manner that upper parts thereof protrude toward the outside without being in contact with the regions of the gap portions G. Therefore, the workpiece W is conveyed in the front-and-back direction X in a state where it is supported on the exposed upper side of each roller 230, and air currents flowing toward the inside are produced in gaps formed around the rollers 23.

That is, according to this conveying apparatus, a conveyance height can be reduced by an amount corresponding to an exposure amount of the upper side of each roller 230 as compared with an example where the rollers 230 are completely accommodated, thereby reducing a size of the apparatus. Additionally, since air currents flowing toward the inside are generated around the rollers 230 by a suction device 60, thus assuredly preventing an abrasion powder or dust produced in the internal space S from scattering toward the outside.

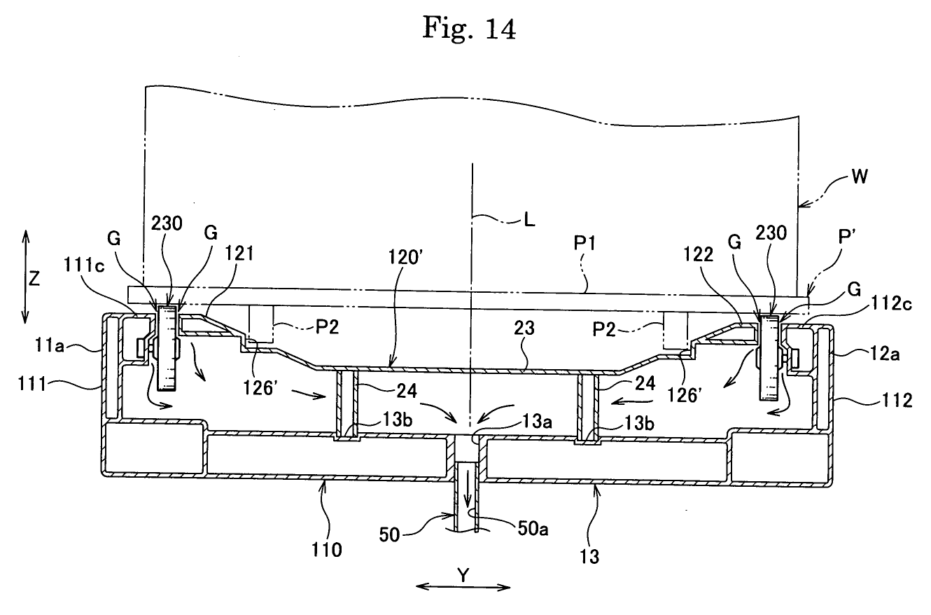

FIG. 14 shows an example where the upper cover of the conveyer apparatus shown in FIGS. 12 and 13 is partially changed. It is to be noted that a workpiece W and a pallet P′ are applied as a conveyance object. That is, in this conveyer apparatus, as shown in FIG. 14, a pair of right and left guide portions 126′ that engage with leg portions P2 of the pallet P′ (a part of the conveyance object) and guide them in a conveying direction (a front-and-back direction) X are integrally provided to an upper cover 120′.

According to this configuration, when conveying the pallet P′ supporting the workpiece W by using rollers 230, since the guide portions 126′ of the upper cover 120′ guide the leg portions P2, and hence the conveyance object (the workpiece W and the pallet P′) can be assuredly conveyed in the front-and-back direction without displacement in a lateral direction Y.

The example where the case defining the pair of right and left gap portions is formed of the lower case 10, 10′, 10″, 10′″, or 110 and the upper cover 20, 20″, 20′″, 120, or 120′ has been explained in conjunction with each of the foregoing embodiments. However, the present invention is not restricted thereto, and a metal plate or the like may be configured and integrally formed to define the pair of gap portions and the internal space.

In each of the foregoing embodiments, the example where the plurality of suction openings 13a and the suction path 50a as the sucking means for sucking air in the case are provided at a substantially central position of the case with respect to the pair of right and left gap portions G has been explained. However, the present invention is not restricted thereto, and a plurality of suction openings and a suction path may be provided to each of the right and left gap portions G. Alternatively, the internal space of the case may be partitioned at the center for each of the right and left gap portions G to form two internal spaces, and the sucking means (the plurality of suction openings and the suction path) may be provided to suck air in each of the internal spaces.

Although the single conveyer apparatus has been explained in each of the foregoing embodiments, the present invention is not restricted thereto. The above-explained conveyer apparatus is determined as one unit, and the plurality of units may be arranged to be used. In a semiconductor manufacturing line and others, these units may be connected so as to snake to be used. Alternatively, these units may be annularly arranged and used in this state to form a closed loop conveying path.

Although the double-speed chain that is the roller chain as the conveyer has been explained in each of the foregoing embodiments, the present invention is not restricted thereto, and a regular roller chain that does not adopt a doubling (double-speed) mechanism may be used.

As explained above, the conveyer apparatus according to the present invention is useful in a semiconductor manufacture field as well as other fields, e.g., an electronic component manufacturing line or a precision machine manufacturing line as long as it is a field where a conveyance object must be conveyed in a clean environment.

What is claimed is:

1. A conveyer apparatus comprising:
a case that defines a pair of right and left gap portions each of which has a predetermined width and extends in a conveying direction of a conveyance object;
a conveyer that is arranged near or in a region adjacent to each of the pair of right and left gap portions and supported by the case to support and convey the conveyance object;
a driving mechanism arranged in an internal space of the case to drive the conveyer; and
sucking means for sucking air in the internal space.

2. The conveyer apparatus according to claim 1,
wherein the conveyer is arranged near under each of the pair of right and left gap portions in the internal space of the case, and
the conveyance object is a pallet that has: leg portions that are inserted into the internal space through the pair of right and left gap portions and supported on the conveyers; and a supporting portion that is supported by the leg portions and positioned above and outside the case to support a workpiece.

3. The conveyer apparatus according to claim 2,
wherein the leg portions of the pallet are formed to be inserted into and removed from the pair of right and left gap portions without restraint.

4. The conveyer apparatus according to claim 1,
wherein the case includes: a lower case that has a pair of right and left conveying frames extending in the conveying direction and a planar frame that couples lower parts of the pair of conveying frames with each other; and an upper cover that faces the planar frame from above to define the internal space in a closed manner and faces the pair of conveying frames from an inside in a lateral direction to define the pair of right and left gap portions.

5. The conveyer apparatus according to claim 4,
wherein the pair of right and left conveying frames and the planar frame are integrally molded.

6. The conveyer apparatus according to claim 4,
wherein the upper cover is formed to be detachable with respect to the lower case.

7. The conveyer apparatus according to claim 1,
wherein the conveyer is an endless belt that is stretched in the conveying direction and arranged in the internal space, and
an upper belt placed on an upper side of the endless belt is arranged to face each of the gap portions from below.

8. The conveyer apparatus according to claim 1,
wherein the conveyer is a roller chain having a plurality of rollers that is stretched in the conveying direction and arranged in the internal space, and
an upper chain placed on an upper side of the roller chain is arranged to face each of the gap portions from below.

9. The conveyer apparatus according to claim 1,
wherein the conveyer is an endless belt stretched in the conveying direction, and
an upper belt placed on an upper side of the endless belt is arranged near each of the gap portions.

10. The conveyer apparatus according to claim 1,
wherein the conveyer is a plurality of rollers arranged in a region of each of the gap portions in a non-contact manner, and
upper parts of the plurality of rollers protrude from each of the gap portions to support the conveyance object.

11. The conveyer apparatus according to claim 1,
wherein the sucking means includes: a plurality of suction openings provided on a lower side at a substantially central position of the case in a lateral direction to be aligned in the conveying direction; and a suction path communicating with the plurality of suction openings.

12. The conveyer apparatus according to claim 4,
wherein the sucking means includes: a plurality of suction openings provided at a substantially central position of the lower case in a lateral direction to be aligned in the conveying direction; and a suction path communicating with the plurality of suction openings.

13. The conveyer apparatus according to claim 1,
wherein a guide portion that engages with a part of the conveyance object and guides the conveyance object in the conveying direction is provided to the case.
